(19) United States
(12) Patent Application Publication
(10) Pub. No.: US 2009/0289553 A1
(43) Pub. Date: Nov. 26, 2009

(54) INTEGRATED CERAMIC METAL HALIDE HIGH FREQUENCY BALLAST ASSEMBLY

(75) Inventors: Glenn Freeman, Danvers, MA (US); Andrew Johnsen, Danvers, MA (US)

Correspondence Address: SENNIGER POWERS LLP (OSR), 100 NORTH BROADWAY, 17TH FLOOR, ST. LOUIS, MO, 63102, US

(73) Assignee: OSRAM SYLVANIA, INC., Danvers, MA (US)

(21) Appl. No.: 12/126,349

(22) Filed: May 23, 2008

(51) Int. Cl. H01K 1/22

(52) U.S. Cl. 315/56

(57) ABSTRACT

A ballast assembly for use with an HID lamp comprising a circuit board, a first electrically conductive heat sink in the form of a first shell positioned on a first side the circuit board and a second electrically conductive heat sink in the form of a second shell positioned on a second side of the circuit board. The first and second shells define an enclosure within which the circuit board and substantially all components on the circuit board are located to dissipate heat and reduce EMI.

### FIELD OF THE INVENTION

The present invention generally relates to assemblies for integrated ceramic metal halide (ICMH) electric lamps. More particularly, the invention is concerned with an ICMH high frequency ballast assembly for HID lamps having thermal and electromagnetic interference (EMI) management for use in threaded sockets.

### BACKGROUND OF THE INVENTION

High intensity discharge (HID) lamps can be very efficient with lumen per watt factors of 100 or more. HID lamps can also provide excellent color rendering. Historically, HID lamps required separate starting and ballasting equipment and therefore could not be used interchangeably with incandescent lamps in standard sockets. This limits their market use to professional applications, and essentially denied them to the general public that could benefit from the technology. With the advent of circuit miniaturization, ballast and starting circuits have become smaller, but their performance has been affected by ambient operating temperature. These miniature ballasts require heat sinking and shielding for electromagnetic interference (EMI), and these factor and others have generally kept the starting and ballasting features separate from the lamp body.

There is then a need for an integral HID lamp with onboard control circuitry that meets UL standards and FCC emission requirements and that has a low thermal path from its integrated circuits to its housing. Because of the high voltages used in integral HID lamps, electrical security has prevented them from being commonly used by consumers. There is a need for an integral HID lamp with little or no safety issues with regard to common uses. There is then a need for an integrated HID lamp that is safe for use in incandescent lamp sockets. There is then a need for an integral HID lamp with onboard control circuitry that suppresses EMI.

### SUMMARY OF THE INVENTION

In one embodiment, a ballast assembly of the invention is for use with an HID lamp comprising a circuit board, a first electrically conductive heat sink in the form of a first shell positioned on a first side the circuit board and a second electrically conductive heat sink in the form of a second shell positioned on a second side of the circuit board. The first and second shells define an enclosure within which the circuit board and substantially all components on the circuit board are located to dissipate heat and reduce EMI.

Other objects and features will be in part apparent and in part pointed out hereinafter.

### BRIEF DESCRIPTION OF THE DRAWINGS

FIG. 1 is a perspective illustration of one embodiment of the ballast assembly of the invention.

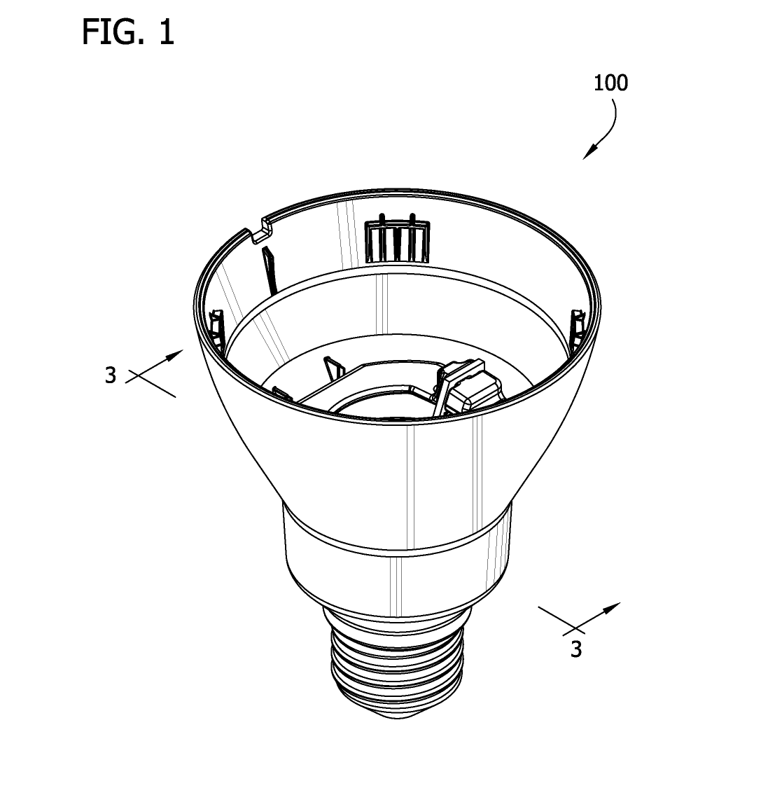

FIG. 2 is an exploded perspective illustration of one embodiment of the assembly of the invention showing the first and second shell 136s and the circuit board 108 which are to be positioned within the base.

FIG. 3 is a cross sectional illustration of one embodiment of the assembly of the invention taken along lines 3-3 of FIG. 1.

FIG. 4 is a cross sectional illustration of one embodiment of the assembly of the invention taken along lines 4-4 of FIG. 3.

FIG. 5 is an exploded perspective illustration of one embodiment of the assembly of the invention showing the first and second shell 136s and the circuit board 108.

Corresponding reference characters indicate corresponding parts throughout the drawings.

### DESCRIPTION OF THE PREFERRED EMBODIMENTS

One aspect of the present invention is directed to a non-contacting, low stress assembly for heat sinking and EMI containment for an ICMH. The assembly has non-contacting heat sinks because the heat sinks do not directly contact any components; instead, the heat sinks engage a periphery of a circuit board 108 carrying the ballast components. A thermally conductive filler between the components and the heat sinks facilitates heat transfer to the heat sinks. The filler may also be located between the circuit board 108 and the heat sinks to facilitate heat transfer from the circuit board 108 to the heat sinks.

The assembly is low stress because no physical loads are applied to the electrical components. Avoiding mechanical stressing increases the life expectancy of the components and does not distort the circuit board 108 or the components. Since the heat sinks encapsulate the circuit board 108 and components, EMI is contained and a high frequency ballast may be used.

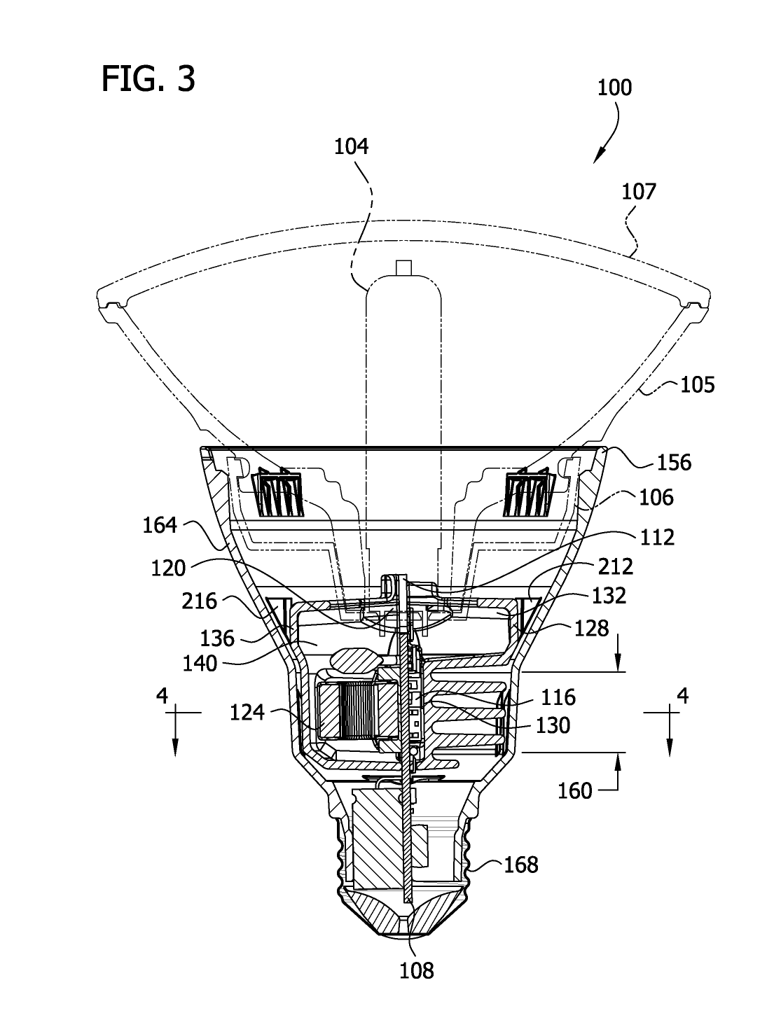

Referring to the drawings and particularly FIG. 3, a ballast assembly 100 is illustrated for use with a lamp assembly including an HID lamp 104, a reflector 105, a reflector support 106 and a lens 107. The ballast assembly 100 includes a circuit board 108 for energizing the lamp. The circuit board 108 has a first side 112 with at least one first circuit component 116 on the first side 112. Additional electrical components on the first side 112 are illustrated. For example, in one embodiment, the components include semiconductors, ceramics and a resonant tank circuit.

The board 108 has a second side 120 with at least one second circuit component 124 on the second side. Additional electrical components on the second side 120 are illustrated. As shown in the figures, the first component is illustrated as a semiconductor device and the second component 124 is illustrated as a toroidal transformer. However, it is contemplated that any one or more components may be on either side of the board 108.

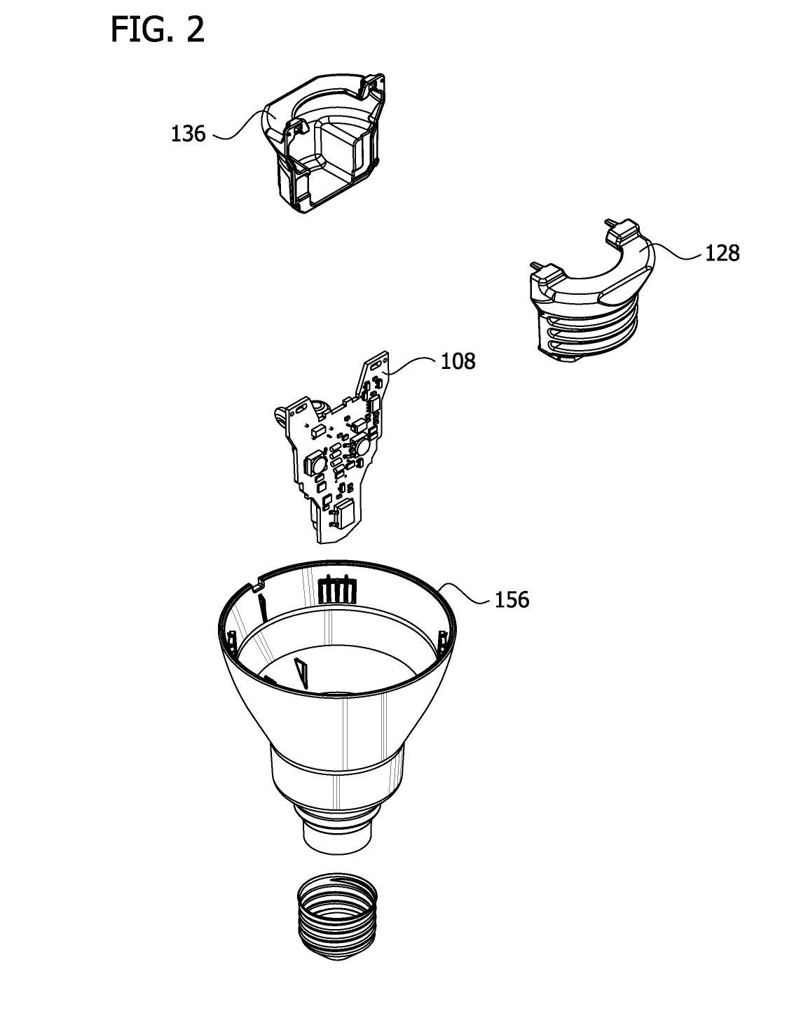

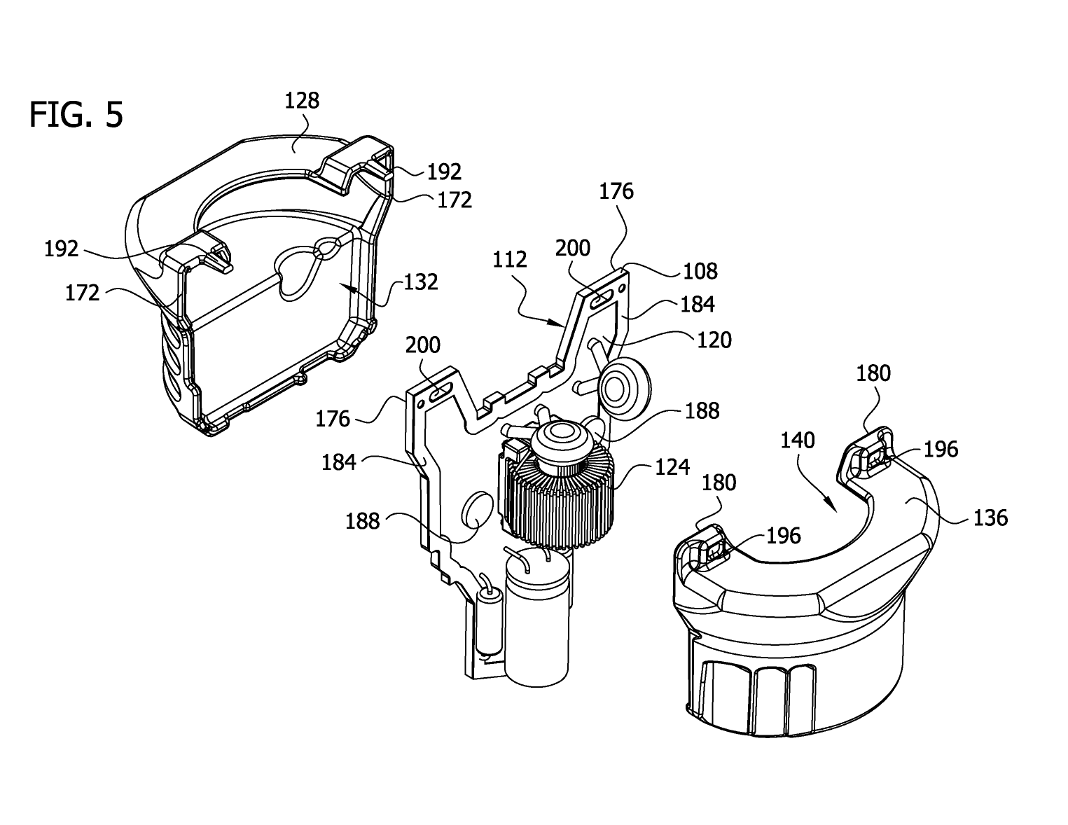

As shown in FIGS. 2 and 5, a heat sink includes a first electrically conductive heat sink section in the form of a first shell 128 defining a first interior volume 132. The first shell 128 is positioned on the first side 112 of the circuit board 108 so that the first circuit component 116 is within the first interior volume 132 and in thermal connection with the first shell 128. As noted herein, the thermal connection is accomplished by transfer of heat generated by the first component 116 and transmitted either by an air space between the component 116 and the shell 128 or by a thermal putty located between the component and the shell. As shown in FIG. 3, in one embodiment, a thermally conductive and electrically non-conductive filler 130 such as a thermal putty which is plastic and non-hardening is positioned between the first shell 128 and the first components 116 to conduct heat from the first components to the first shell 128.

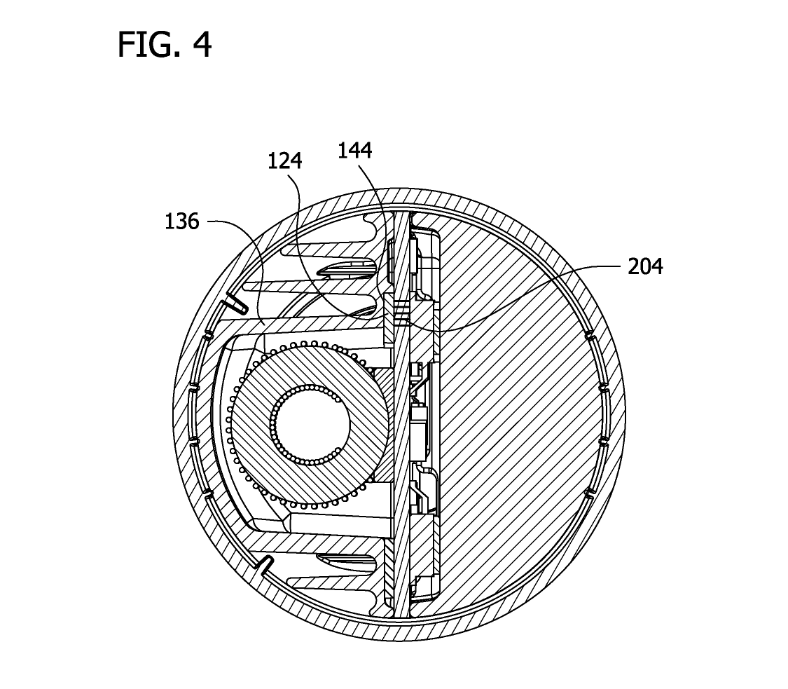

The heat sink includes a second electrically conductive heat sink in the form of a second shell 136 defining a second interior volume 140, the second shell 136 positioned on the second side 120 of the circuit board 108 so that the second circuit component 124 is within the second interior volume 140 and in thermal connection with the second shell 136. As noted herein, the thermal connection is accomplished by transfer of heat generated by the second component 124 and transmitted either by an air space between the component 124 and the shell 136 or by a thermal putty located between the component and the shell. As shown in FIG. 4, in one embodiment, a thermally conductive and electrically non-conductive filler 144 such as a thermal putty which is plastic and non-hardening is positioned between the second shell 136 and the second components 124 to conduct heat from the second components to the second shell 136.

As shown in FIG. 3, the first shell 128 and second shell 136 define an enclosure within which the circuit board 108 and substantially all components 116, 124 on the circuit board 108 are enclosed within the first and second interior volumes 132, 140. The first shell 128 and the second shell 136 may be provided with a plurality of fins 148, 152, respectively, for radiating the heat absorbed by the shell.

In one embodiment as shown in FIGS. 2 and 3, the assembly 100 comprises an electrically non-conductive base 156 having a circular cross section for the assembly configured such that the first and second shell 136s and the circuit board 108 fit within the base. The base may be a plastic housing including a cylindrical sleeve 160 urging the first shell 128 against the first side 112 of the circuit board 108 and urging the second shell 136 against the second side 120 of the circuit board 108. As a result, the first shell 128 is held in place against the first side of the circuit board 108 by the sleeve 160 and the second shell 136 is held in place against the second side of the circuit board 108 by the sleeve 160. It is contemplated that the sleeve comprises an electrically insulated enclosure surrounding the shells and the circuit board 108 in order to meet UL and other safety requirements. The upper portion of the sleeve 160 may terminate in a conical configuration 164 for accommodating the lamp 104 and any reflector or lens surrounding the lamp 104. Additionally, the lower portion of the sleeve 160 may taper into a threaded end 168 for engaging a socket (not shown).

In some embodiments, it is preferable that no substantial mechanical loads are placed on the circuit board 108 by either of the first shell 128 or the second shell 136. In this way, the circuit board 108 has a planar configuration which corresponds to the planar configuration of the circuit board 108 without the first shell 128 on the first side of the circuit board 108 or the second shell 136 on the second side of the circuit board 108.

In order to reduce the loads in one embodiment as shown in FIG. 5, a first periphery 172 of the first shell 128 engages a first edge 176 on the first side 112 of the circuit board 108. As a result, the first component 116 and any first additional components on the first side of the circuit board 108 are positioned within the first volume 132 such that there is no direct contact between the first shell 128 and the first component 116, and such that there is no direct contact between the first shell 128 and the first additional components. Thus, no mechanical loads are placed on the first component 116 by the first shell 128 and no mechanical loads are placed on the first additional components by the first shell 128.

Similarly, a second periphery 180 of the second shell 136 engages a second edge 184 on the second side 120 of the circuit board 108. As a result, the second component 124 and any second additional components on the second side of the circuit board 108 are positioned within the second volume 140 such that there is no direct contact between the second shell 136 and the second component 124, and such that there is no direct contact between the second shell 136 and the second additional component. Thus, no mechanical loads are placed on the second component 124 by the second shell 136 and no mechanical loads are placed on the second additional components by the second shell 136.

In summary, no substantial mechanical loads are placed on the circuit board 108 by the first shell 128 and the second shell 136 and the circuit board 108 has a planar configuration which corresponds to the planar configuration of the circuit board 108 without the shells. No additional fixtures such as screws connecting the shells to the circuit board 108 or to each other are used. No stress is placed on the ceramic components on the board so that cracking or other damage to the components is minimized.

Optionally, posts 192 integral with the first shell 128 are received within and frictionally engage openings 196 within in the second shell 136 for aligning the shells. In addition, the circuit board 108 may include slots 200 within which posts 196 of the first shell 128 are positioned and through which the posts pass.

In one embodiment, the first edge 176 of the first side 112 of the circuit board 108 comprises a ground trace connected to the first component 116. Since it is contemplated that the first shell 128 is a conductive material, its periphery 172 is electrically connected to the ground trace and EMI from the first component 116 is suppressed. Similarly, the second edge 184 of the second side 120 of the circuit board 108 comprises a ground trace connected to the second component 124. Since it is contemplated that the second shell 136 is a conductive material, its periphery 180 is electrically connected to the ground trace and EMI from the second component 124 is suppressed.

In one embodiment, the ballast 100 comprises high frequency components which are relatively small. Because of the heat dissipation and EMI suppression of the various embodiments of the invention, high frequency components may be employed. By high frequency, it is meant that at least one of the first and second components 116, 124 oscillates at a frequency which is higher than 1 MHZ to avoid any acoustic resonant frequency of the HID lamp 104. For example, the frequency is in the range of 2 MHz to 3 MHz, and is approximately 2.6 MHz.

The filler 130 or air within the first volume is between the first shell 128 and the first components so that the first shell 128 is electrically isolated from the first components. Similarly, the filler 144 or air within the second volume is between the second shell 136 and the second components so that the second shell 136 is electrically isolated from the second components. A non-hardening thermally conductive, electrically non-conductive gap filler 188 (see FIG. 5) (such as a thermal putty or the fillers noted above), which fillers conducts heat but do not conduct electricity may also be located between the circuit board 108 and the heat sinks to facilitate heat transfer from the circuit board 108 to the heat sinks.

In one embodiment, the circuit board 108 includes vias 204 contacting a component such as component 124 (FIG. 4). The vias are filled with a thermally conductive and electrically non-conductive material and are in thermal connection to at least one of the first and second heat sinks. As shown in FIG. 4, a thermally conductive, electrically non-conductive filler 144 is between the vias and the second shell 136.

Optionally, one embodiment may include a first inwardly directed crush rib 208 on an interior surface 212 of the sleeve 160 engaging the first shell 128 and a second inwardly directed crush rib 216 on an interior surface 212 of the sleeve engaging the second shell 136. As a result, the first shell 128 is held in place against the first side of the circuit board 108 by the first rib 208 and the second shell 136 is held in place against the second side of the circuit board 108 by the second rib 216.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

Having described aspects of the invention in detail, it will be apparent that modifications and variations are possible without departing from the scope of aspects of the invention as defined in the appended claims.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A ballast assembly for use with a lamp assembly including an HID lamp, said ballast assembly comprising:
a circuit board for energizing the HID lamp, said circuit board having a first side with a first circuit component on said first side and having a second side with a second circuit component on said second side;
a first electrically conductive heat sink in the form of a first shell defining a first interior volume, the first shell positioned on the first side of the circuit board such that the first circuit component is within the first interior volume and in thermal connection with the first shell; and
a second electrically conductive heat sink in the form of a second shell defining a second interior volume, the second shell positioned on the second side of the circuit board such that the second circuit component is within the second interior volume and in thermal connection with the second shell wherein the first and second shells define an enclosure within which the circuit board and substantially all components on the circuit board are enclosed within the first and second interior volumes.

2. The assembly of claim 1 further comprising thermally conductive and electrically non-conductive filler positioned between the first shell and the first components for conducting heat from the first components to the first shell.

3. The assembly of claim 1 further comprising thermally conductive and electrically non-conductive filler positioned between the first shell and the first side of the circuit board for conducting heat from the first side of the circuit board to the first shell.

4. The assembly of claim 1 further comprising a circular electrically non-conductive base for the assembly wherein the first and second shell and the circuit board are within the base.

5. The assembly of claim 4 wherein the base comprises a plastic housing sleeve urging the first shell against the first side of the circuit board and urging the second shell against the second side of the circuit board such that the first shell is held in place against the first side of the circuit board by the sleeve and such that the second shell is held in place against the second side of the circuit board by the sleeve.

6. The assembly of claim 5 wherein the sleeve comprises an electrically insulated enclosure surrounding the shells and the circuit board.

7. The assembly of claim 5 wherein a first periphery of the first shell engages a first edge on the first side of the circuit board and wherein the first component and any first additional components on the first side of the circuit board are positioned within the first volume such that there is no direct contact between the first shell and the first components, such that there is no direct contact between the first shell and the first additional components so that no mechanical loads are placed on the first components by the first shell and no mechanical loads are placed on the first additional components by the first shell whereby no substantial mechanical loads are placed on the circuit board by the first shell and the circuit board has a planar configuration which corresponds to the planar configuration of the circuit board when the first shell is not on the first side of the circuit board.

8. The assembly of claim 7 further comprising a first inwardly directed crush rib on an interior surface of the sleeve engaging the first shell and a second inwardly directed crush rib on an interior surface of the sleeve engaging the second shell such that the first shell is held in place against the first side of the circuit board by the first rib and such that the second shell is held in place against the second side of the circuit board by the second rib.

9. The assembly of claims 1 wherein a first periphery of the first shell engages a first edge on the first side of the circuit board and wherein the first component and any first additional components on the first side of the circuit board are positioned within the first volume such that there is no direct contact between the first shell and the first components, such that there is no direct contact between the first shell and the first additional components so that no mechanical loads are placed on the first components by the first shell and no mechanical loads are placed on the first additional components by the first shell whereby no substantial mechanical loads are placed on the circuit board by the first shell and the circuit board has a planar configuration which corresponds to the planar configuration of the circuit board when the first shell is not on the first side of the circuit board.

10. The assembly of claim 9 further comprising a thermally conductive and electrically non-conductive filler positioned between the first shell and the first components for conducting heat from the first components to the first shell.

11. The assembly of claim 9 wherein the first edge of the first side of the first circuit board comprises a ground trace connected to the first component and wherein the first periphery of the first shell is electrically connected to the ground trace whereby EMI from the first component is suppressed.

12. The assembly of claim 9 wherein at least one of the first and second components oscillates at a frequency which is higher than an acoustic resonant frequency of the HID lamp.

13. The assembly of claim 12 wherein the frequency is in the range of 2 MHz to 3 MHz.

14. The assembly of claim 13 wherein the frequency is approximately 2.6 MHz.

15. The assembly of claim 9 wherein a second periphery of the second shell engages a second edge on the second side of the circuit board and wherein the second component and any second additional components on the second side of the circuit board are positioned within the second volume such that there is no direct contact between the second shell and the second components, such that there is no direct contact between the second shell and the second additional components so that no mechanical loads are placed on the second components by the second shell and no mechanical loads are placed on the second additional components by the second shell whereby no substantial mechanical loads are placed on the circuit board by the second shell and the circuit board has a planar configuration which corresponds to the planar configuration of the circuit board when the second shell is not on the second side of the circuit board and whereby no additional fixtures such as screws connect the shells to the circuit board or to each other.

16. The assembly of claim 15 further comprising thermally conductive and electrically non-conductive filler positioned between the second shell and the second components for conducting heat from the second components to the second shell.

17. The assembly of claim 15 wherein the filler or air within the first volume is between the first shell and the first components so that the first shell is electrically isolated from the first components and wherein the filler or air within the second volume is between the second shell and the second components so that the second shell is electrically isolated from the second components.

18. The assembly of claim 1 further comprising posts integral with the first shell and openings within the second shell for receiving the posts.

19. The assembly of claim 18 wherein the circuit board includes slots within which posts of the first shell are positioned.

20. The assembly of claim 1 wherein the circuit board includes vias contacting a component, said vias filled with a thermally conductive material, said vias in thermal connection to at least one of the first and second heat sinks.

21. The assembly of claim 20 further comprising a thermally conductive, electrically non-conductive filler between the vias and the heat sink.
